(19) United States
(12) Patent Application Publication
(10) Pub. No.: US 2019/0244324 A1
(43) Pub. Date: Aug. 8, 2019

(54) DISPLAY CONTROL APPARATUS

(71) Applicant: AISIN SEIKI KABUSHIKI KAISHA, Kariya-shi, Aichi (JP)

(72) Inventors: Kazuya WATANABE, Anjo-shi (JP); Yoji INUI, Ama-gun (JP); Kinji YAMAMOTO, Anjo-shi (JP); Takashi HIRAMAKI, Nagoya-shi (JP); Takuya HASHIKAWA, Nagoya-shi (JP); Tetsuya MARUOKA, Okazaki-shi (JP); Naotaka KUBOTA, Aioi-shi (JP); Osamu KIMURA, Ichinomiya-shi (JP); Itsuko FUKUSHIMA, Anjo-shi (JP)

(73) Assignee: AISIN SEIKI KABUSHIKI KAISHA, Kariya-shi, Aichi (JP)

(21) Appl. No.: 16/340,496

(22) PCT Filed: Oct. 3, 2017
(86) PCT No.: PCT/JP2017/035945

§ 371 Date: Apr. 9, 2019

(30) Foreign Application Priority Data
Oct. 11, 2016 (JP) 2016-200093

(51) Int. Cl. G06T 1/20; B60R 1/00; G06T 1/00; G06T 7/55

(52) U.S. Cl. CPC G06T 1/20; G06T 7/55; G06T 1/0007; B60R 1/00

(57) ABSTRACT

A display control device according to an embodiment includes an acquirer configured to acquire image data from an imager to image surroundings of a vehicle, storage that stores therein vehicle-shape data representing a three-dimensional shape of the vehicle, and a display processor configured to display a certain region of the vehicle-shape data at transmittance different from transmittance of another region, when superimposing, for display, the vehicle-shape data on display data which is based on the image data and represents the surroundings of the vehicle.

### TECHNICAL FIELD

The present invention relates generally to a display control device.

### BACKGROUND ART

Conventionally, techniques for imaging the surrounding environment of a vehicle with an imaging device mounted on the vehicle and displaying resultant images are known.

There is a technique for superimposing images of a vehicle interior and a vehicle on image data representing the surrounding environment, for display of the surrounding environment.

### CITATION LIST

### Patent Literature

Patent Document 1: Japanese Laid-open Patent Application Publication No. 2014-197818

### SUMMARY OF INVENTION

### Problem to be Solved by the Invention

In related art, changing transmittance of each region of vehicle interior at the time of superimposing the vehicle interior image on the image data representing the surrounding environment is known, for the sake of understanding of the surrounding environment. Such a technique, however, does not consider superimposition of vehicle-shape data representing a three-dimensional shape of the vehicle on the image data of the surrounding environment.

In view of the above, the present invention aims to provide a display control device that enables recognition of the surrounding environment from image data on which vehicle-shape data is superimposed.

### Means for Solving Problem

A drive control device according to an embodiment includes, as an example, an acquirer configured to acquire image data from an imager that images surroundings of a vehicle; storage that stores therein vehicle-shape data representing a three-dimensional shape of the vehicle; and a display processor configured to display a certain region of the vehicle-shape data at transmittance different from transmittance of another region different from the certain region, when superimposing, for display, the vehicle-shape data on display data, the display data being based on the image data and representing the surroundings of the vehicle. Thus, the driver can check the surroundings of the vehicle in accordance with the situation of the certain region and another region.

According to the drive control device of the embodiment, as an example, the display processor displays the certain region of the vehicle-shape data at different transmittance from transmittance of the another region, the certain region being a region representing at least one or more of bumpers or wheels. Thus, the driver can check a region including at least one or more of the bumpers or the wheels, and at the same time can check the surroundings of the vehicle.

According to the drive control device of the embodiment, as an example, the display processor displays the vehicle-shape data at such transmittance that heightens or lowers from the certain region being a region representing a wheel to the another region being a region representing a roof. Thus, the driver can check the periphery of the vehicle and the situation of the vehicle.

According to the drive control device of the embodiment, as an example, the storage stores therein a shape of an interior of the vehicle as the vehicle-shape data. In superimposing the vehicle-shape data on the display data for display with a viewpoint situated inside the vehicle-shape data, the display processor displays the interior and the surroundings of the vehicle while changing the transmittance from a floor to a ceiling in the interior. Thus, the driver can check the periphery of the vehicle and the vehicle interior.

According to the drive control device of the embodiment, as an example, the display processor changes modes of transparency of the vehicle-shape data when the viewpoint is situated inside the vehicle-shape data and when the viewpoint is situated outside the vehicle-shape data. This can achieve display in accordance with the setting of the viewpoint, which enables the driver to more properly check the surroundings of the vehicle.

According to the drive control device of the embodiment, as an example, the acquirer further acquires steering-angle data representing steering by a driver of the vehicle. For display of the display data on which the vehicle-shape data is superimposed, when determining on the basis of the steering-angle data that the driver has steered right or left, the display processor displays the certain region and the another region at different transmittances, the certain region being a region in a turning direction of the vehicle, the another region being a region in a direction opposite to the turning direction of the vehicle. This can achieve display in response to the steering of the driver, which enables the driver to more properly check the surroundings of the vehicle.

According to the drive control device of the embodiment, as an example, the acquirer further acquires detection data from a detector that detects an object around the vehicle. The display processor further displays the certain region and the another region at different transmittances on the basis of the detection data, the certain region being a region corresponding to part of the vehicle closer to the object. Thus, the driver can know the positional relationship between the vehicle and the object and properly check the surroundings of the vehicle.

### BRIEF DESCRIPTION OF DRAWINGS

FIG. 1 is a perspective view of an exemplary vehicle incorporating a display control device according to an embodiment, with a vehicle interior partially transparent;

FIG. 2 is a plan view (bird's-eye view) of the exemplary vehicle incorporating the display control device of the embodiment;

FIG. 3 is a block diagram of an exemplary configuration of a display control system including the display control device of the embodiment;

FIG. 4 is a block diagram illustrating a functional configuration of an ECU serving as the display control device of the embodiment;

FIG. 5 illustrates exemplary vehicle-shape data stored in a vehicle-shape data storage of the embodiment;

FIG. 6 illustrates exemplary vehicle-shape data with a region, corresponding to a vehicle height of two meters or more, completely transparent;

FIG. 7 illustrates exemplary vehicle-shape data with a region, corresponding to a vehicle height of one meter or more, completely transparent;

FIG. 8 illustrates exemplary vehicle-shape data with a region behind a certain position of the vehicle, completely transparent;

FIG. 9 illustrates exemplary vehicle-shape data with a region, corresponding to a vehicle height of one meter or less, completely transparent;

FIG. 10 is a schematic exemplary explanatory diagram depicting projection of image data by an image combiner onto a virtual projection plane in the embodiment;

FIG. 11 is a schematic exemplary side view of the vehicle-shape data and the virtual projection plane;

FIG. 12 is a diagram illustrating exemplary viewpoint image data displayed by a display processor of the embodiment;

FIG. 13 is a diagram illustrating exemplary viewpoint image data displayed by the display processor of the embodiment;

FIG. 14 is a diagram illustrating exemplary viewpoint image data displayed by the display processor of the embodiment;

FIG. 15 is a diagram illustrating exemplary viewpoint image data displayed by the display processor of the embodiment;

FIG. 16 is a diagram illustrating exemplary viewpoint image data displayed by the display processor of the embodiment;

FIG. 17 is a flowchart illustrating a first display procedure of the ECU of the embodiment;

FIG. 18 is a flowchart illustrating a second display procedure of the ECU of the embodiment;

FIG. 19 is a flowchart illustrating a third display procedure of the ECU of the embodiment;

FIG. 20 is an exemplary diagram illustrating a contact point between the wheels and the ground to be a reference to a vehicle height of the embodiment;

FIG. 21 is a diagram illustrating an exemplary horizontal plane to be a reference to a vehicle height in a first modification; and

FIG. 22 is a diagram illustrating an exemplary screen display displayed by a display processor in a modification.

### DESCRIPTION OF EMBODIMENTS

Exemplary embodiments of the present invention will now be disclosed. Features of the embodiments described below, and actions, results, and effects exerted by the features are merely exemplary. The present invention can be implemented by a configuration other than those described in the following embodiments, and can achieve at least one of various effects based on a basic configuration and derivative effects.

In the present embodiment the vehicle 1 including a display control device (display control system) may be, for example, an internal-combustion automobile including an internal combustion (not illustrated) as a power source, an electric automobile or a fuel-cell automobile including an electric motor (not illustrated) as a power source, a hybrid automobile including both of them as a power source, or an automobile including another power source. The vehicle 1 can incorporate a variety of transmissions and a variety of devices such as systems and/or parts and components necessary for driving the internal combustion or the electric motor. As for a drive system, the vehicle 1 can be a four-wheel drive vehicle that transmits power to four wheels 3 and uses all the wheels 3 as driving wheels. Systems, numbers, and layout of devices involving in driving the wheels 3 can be variously set. The drive system is not limited to a four-wheel drive, and may include, for example, a front-wheel drive and a rear-wheel drive.

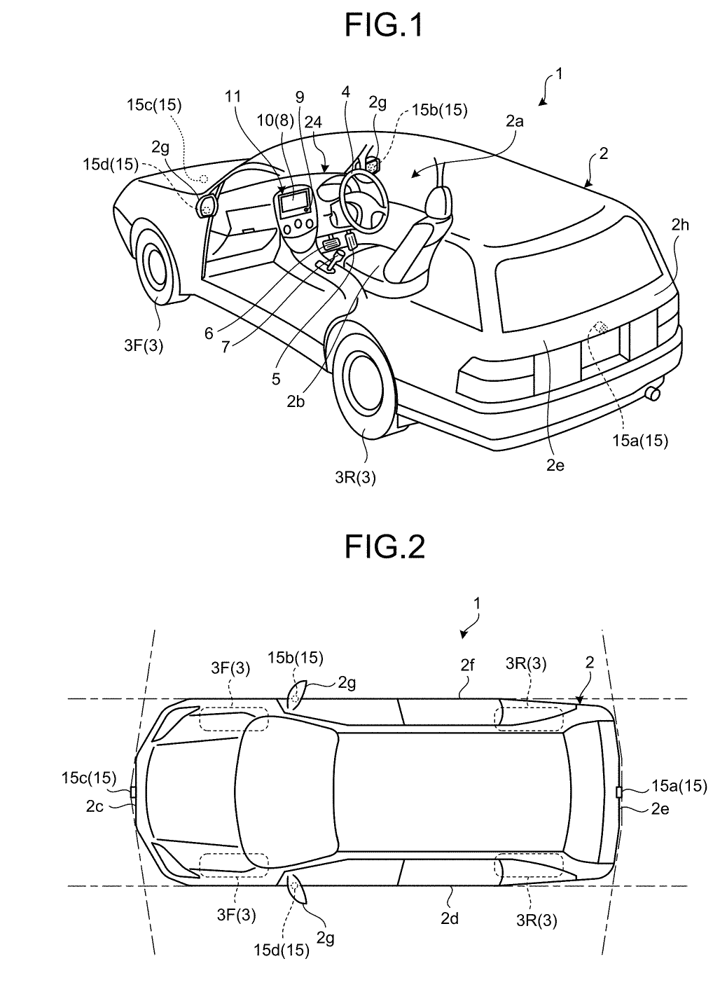

As illustrated in FIG. 1, the vehicle 1 includes a body 2 defining an interior 2a to accommodate an occupant or occupants (not illustrated). The vehicle interior 2a includes a steering 4, an accelerator 5, a brake 6, a gearshift 7, and other components, which face a seat 2b of a driver being an occupant. The steering 4 includes a steering wheel protruding from a dashboard 24 by way of example. The accelerator 5 includes, for example, an accelerator pedal located near the feet of the driver. The brake 6 includes, for example, a brake pedal located near the feet of the driver. The gearshift 7 includes, for example, a shift lever projecting from the center console. The steering 4, the accelerator 5, the brake 6, and the gearshift 7 are not limited to these examples.

The vehicle interior 2a further accommodates a display 8 and an audio output device 9. Examples of the display 8 include a liquid crystal display (LCD) and an organic electroluminescent display (OELD). Examples of the audio output device 9 include a speaker. The display 8 is covered by a transparent operation input 10 such as a touchscreen. The occupant can view images displayed on the screen of the display 8 through the operation input 10. The occupant can also touch, press, and move the operation input with his or her finger or fingers at positions corresponding to the images displayed on the screen of the display device for executing operational inputs. The display 8, the audio output device 9, and the operation input 10 are, for example, included in a monitor 11 disposed in the center of the dashboard 24 in the vehicle width direction, that is, transverse direction. The monitor 11 can include an operation input (not illustrated) such as a switch, a dial, a joystick, and a push button. Another audio output device (not illustrated) may be disposed in the vehicle interior 2a at a different location from the monitor 11 to be able to output audio from the audio output device 9 of the monitor 11 and another audio output device. For example, the monitor 11 can be shared by a navigation system and an audio system.

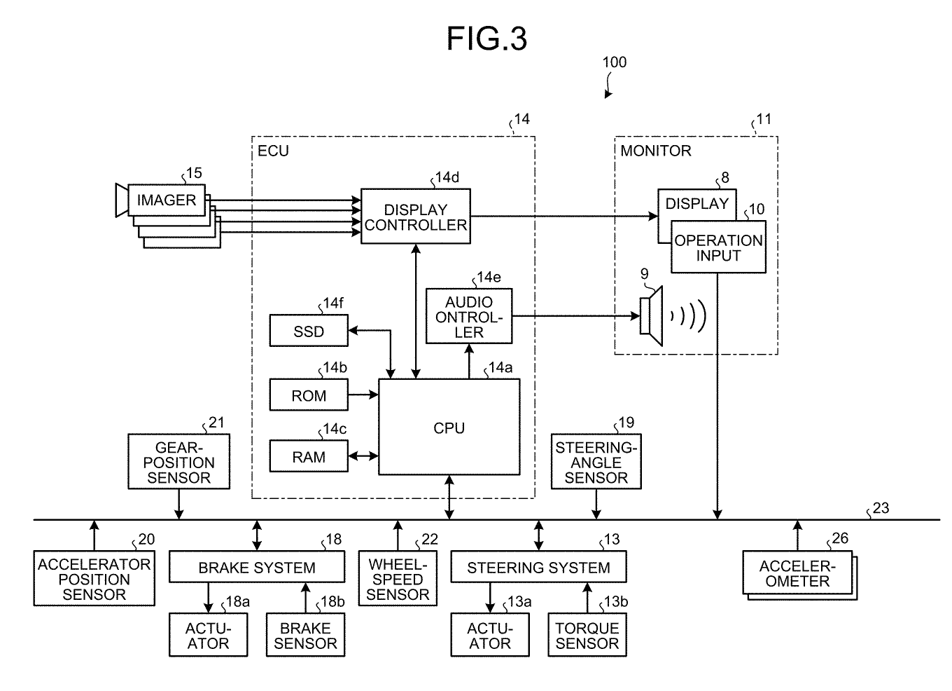

As illustrated in FIG. 1 and FIG. 2, the vehicle 1 represents, for example, a four-wheel automobile including two right and left front wheels 3F and two right and left rear wheels 3R. The four wheels 3 may be all steerable. As illustrated in FIG. 3, the vehicle 1 includes a steering system 13 to steer at least two of the wheels 3. The steering system 13 includes an actuator 13a and a torque sensor 13b. The steering system 13 is electrically controlled by, for example, an electronic control unit (ECU) 14 to drive the actuator 13a. Examples of the steering system 13 include an electric power steering system and a steer-by-wire (SBW) system. The steering system 13 allows the actuator 13a to add torque, i.e., assist torque to the steering 4 to apply additional steering force and turn the wheels 3. The actuator 13a may turn one or two or more of the wheels 3. The torque sensor 13b detects, for example, torque applied to the steering 4 by the driver.

As illustrated in FIG. 2, the vehicle body 2 includes a plurality of imagers 15, for example, four imagers 15a to 15d. Examples of the imagers 15 include a digital camera incorporating image sensors such as a charge coupled device (CCD) and a CMOS image sensor (CIS). The imagers 15 can output video data (image data) at a certain frame rate. Each of the imagers 15 includes a wide-angle lens or a fisheye lens and can photograph the horizontal range of, for example, from 140 to 220 degrees. The optical axes of the imagers 15 may be inclined obliquely downward. The imager 15 sequentially photographs the outside environment around the vehicle 1 including a road surface where the vehicle 1 is movable and objects (such as obstacles, rocks, dents, puddles, and ruts) around the vehicle 1, and outputs the images as image data.

The imager 15a is, for example, located at a rear end 2e of the vehicle body 2 on a wall of a hatch-back door 2h under the rear window. The imager 15b is, for example, located at a right end 2f of the vehicle body 2 on a right side mirror 2g. The imager 15c is, for example, located at the front of the vehicle body 2, that is, at a front end 2c of the vehicle body 2 in vehicle length direction on a front bumper or a front grill. The imager 15d is, for example, located at a left end 2d of the vehicle body 2 on a left side mirror 2g. The ECU 14 of a display control system 100 can perform computation and image processing on image data generated by the imagers 15, thereby creating an image at wider viewing angle and a virtual overhead image of the vehicle 1 from above. The ECU 14 performs computation and image processing on wide-angle image data generated by the imagers 15 to generate, for example, a cutout image of a particular area, image data representing a particular area alone, and image data with a particular area highlighted. The ECU 14 can convert (viewpoint conversion) image data into virtual image data that is generated at a virtual viewpoint different from the viewpoint of the imagers 15. The ECU 14 causes the display 8 to display the generated image data to provide peripheral monitoring information for allowing the driver to conduct safety check of the right and left sides of the vehicle 1 and around the vehicle 1 while viewing the vehicle 1 from above.

As illustrated in FIG. 3, the display control system 100 (display control device) includes, in addition to the ECU 14, the monitor 11, and the steering system 13, a brake system 18, a steering-angle sensor 19, an accelerator position sensor 20, a gear-position sensor 21, a wheel-speed sensor 22, an accelerometer 26, and other devices, which are electrically connected to one another through a in-vehicle network 23 being an electric communication line. Examples of the in-vehicle network 23 include a controller area network (CAN). The ECU 14 transmits a control signal through the in-vehicle network 23, thereby controlling the steering system 13 and the brake system 18. Through the in-vehicle network 23, the ECU 14 can receive results of detection of the torque sensor 13b, a brake sensor 18b, the steering-angle sensor 19, the accelerator position sensor 20, the gear-position sensor 21, the wheel-speed sensor 22, and the accelerometer 26, and operation signals of the operation input 10, for example.

The ECU 14 includes, for example, a central processing unit (CPU) 14a, a read only memory (ROM) 14b, a random access memory (RAM) 14c, a display controller 14d, an audio controller 14e, and a solid state drive (SSD, a flash memory) 14f. The CPU 14a loads a stored (installed) program from a nonvolatile storage device such as the ROM 14b and executes computation in accordance with the program. For example, the CPU 14a executes image processing involving an image to be displayed on the display 8. The CPU 14a executes, for example, computation and image processing to image data generated by the imagers 15 to detect presence or absence of a particular region to watch out on an estimated course of the vehicle 1 and notify a user (driver or passenger) of the particular region to watch out by changing a display mode of a course indicator (estimated course line) that indicates an estimated traveling direction of the vehicle 1.

The RAM 14c transiently stores therein various kinds of data used for the computation of the CPU 14a. Of the computation by the ECU 14, the display controller 14d mainly executes image processing on image data generated by the imagers 15 and image processing (such as image composition) on image data to be displayed on the display 8. The audio controller 14e mainly executes processing on audio data output from the audio output device 9, of the computation of the ECU 14. The SSD 14f is a rewritable nonvolatile storage and can store therein data upon power-off of the ECU 14. The CPU 14a, the ROM 14b, and the RAM 14c can be integrated in the same package. The ECU 14 may include another logical operation processor such as a digital signal processor (DSP) or a logic circuit, instead of the CPU 14a. The SSD 14f may be replaced by a hard disk drive (HDD). The SSD 14f and the HDD may be provided separately from the ECU 14 for peripheral monitoring.

Examples of the brake system 18 include an anti-lock brake system (ABS) for preventing locking-up of the wheels during braking, an electronic stability control (ESC) for preventing the vehicle 1 from skidding during cornering, an electric brake system that enhances braking force (performs braking assistance), and a brake by wire (BBW). The brake system 18 applies braking force to the wheels 3 and the vehicle 1 through an actuator 18a. The brake system 18 is capable of detecting signs of lock-up of the brake during braking and spinning and skidding of the wheels 3 from, for example, a difference in the revolving speeds between the right and left wheels 3 for various types of control. Examples of the brake sensor 18b include a sensor for detecting the position of a moving part of the brake 6. The brake sensor 18b can detect the position of a brake pedal being a movable part. The brake sensor 18b includes a displacement sensor.

The steering-angle sensor 19 represents, for example, a sensor for detecting the amount of steering of the steering 4 such as a steering wheel. The steering-angle sensor 19 includes, for example, a Hall element. The ECU 14 acquires the steering amount of the steering 4 operated by the driver and the steering amount of each wheel 3 during automatic steering from the steering-angle sensor 19 for various kinds of control. Specifically, the steering-angle sensor 19 detects the rotation angle of a rotational part of the steering 4. The steering-angle sensor 19 is an example of angle sensor.

The accelerator position sensor 20 represents, for example, a sensor for detecting the position of a moving part of the accelerator 5. Specifically, the accelerator position sensor 20 can detect the position of an accelerator pedal being a movable part. The accelerator position sensor 20 includes a displacement sensor.

The gear-position sensor 21 represents, for example, a sensor for detecting the position of a moving part of the gearshift 7. The gear-position sensor 21 can detect the position of a lever, an arm, or a button as a movable part. The gear-position sensor 21 may include a displacement sensor or may serve as a switch.

The wheel-speed sensor 22 represents a sensor for detecting the amount of revolution and the revolving speed per unit time of the wheels 3. The wheel-speed sensor 22 outputs the number of wheel speed pulses indicating the detected revolving speed, as a sensor value. The wheel-speed sensor 22 may include, for example, a Hall element. The ECU 14 acquires the sensor value from the wheel-speed sensor 22 and computes the moving amount of the vehicle 1 from the sensor value for various kinds of control. The wheel-speed sensor 22 may be included in the brake system 18. In this case, the ECU 14 acquires results of detection of the wheel-speed sensor 22 through the brake system 18.

The accelerometer 26 is, for example, mounted on the vehicle 1. The ECU 14 computes longitudinal inclination (pitch angle) and lateral inclination (roll angle) of the vehicle 1 in accordance with a signal from the accelerometer 26. The pitch angle refers to an angle of inclination of the vehicle 1 with respect to the transverse axis of the vehicle 1. The pitch angle is zero degree when the vehicle 1 is located on a horizontal plane (the ground or a road surface). The roll angle refers to an angle of inclination of the vehicle 1 with respect to the longitudinal axis of the vehicle 1. The roll angle is zero degree when the vehicle 1 is located on a horizontal plane (the ground or a road surface). That is, the accelerometer 26 can detect the location of the vehicle 1 on a horizontal road surface or on a slope (upward or downward road surface). If the vehicle 1 is equipped with an ESC, the existing accelerometer 26 of the ESC is used. The present embodiment is not intended to limit the accelerometer 26. The accelerometer may be any sensor capable of detecting the acceleration of the vehicle 1 in the lengthwise and transverse directions.

The configurations, layout, and electrical connection of the above sensors and actuators are merely exemplary, and the sensors and actuators can be set (changed) as appropriate.

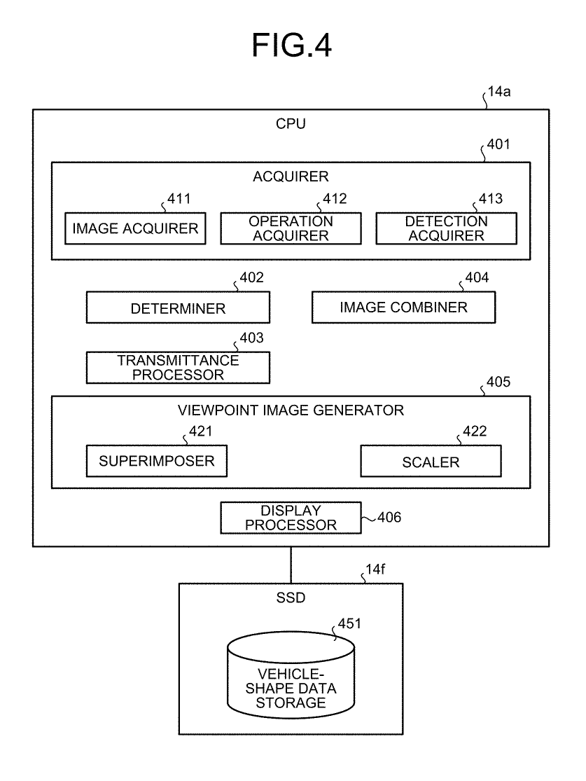

The CPU 14a of the ECU 14 displays the surrounding environment of the vehicle 1 on the basis of image data, as described above. To implement this function, the CPU 14a includes various modules, as illustrated in FIG. 4. The CPU 14a includes, for example, an acquirer 401, a determiner 402, a transmittance processor 403, an image combiner 404, a viewpoint image generator 405, and a display processor 406. These modules can be implemented by loading an installed and stored program from a storage such as the ROM 14b and executing the program.

The SSD 14f includes, for example, a vehicle-shape data storage 451 that stores therein vehicle-shape data representing a three-dimensional shape of the vehicle 1. The vehicle-shape data stored in the vehicle-shape data storage 451 includes the exterior shape and the interior shape of the vehicle 1.

The acquirer 401 includes an image acquirer 411, an operation acquirer 412, and a detection acquirer 413 to acquire information necessary to display the surroundings of the vehicle 1.

The acquirer 401 includes the image acquirer 411, the operation acquirer 412, and the detection acquirer 413 to acquire information (for example, certain data externally acquired or image data) necessary to display the surroundings of the vehicle 1.

The operation acquirer 412 acquires operation data representing the operation of the driver, through the operation input 10. The operation data may include, for example, rescaling operation to a screen displayed on the display 8 and viewpoint changing operation to the screen displayed on the display 8. The operation acquirer 412 further acquires operation data representing a gear shift and steering-angle data representing steering of the driver of the vehicle 1. The operation acquirer 412 also acquires operation data representing turning-on of the blinker by the driver of the vehicle 1.

The detection acquirer 413 acquires detection data from a detector that detects objects around the vehicle 1. In the present embodiment, an exemplary detector may be stereo cameras when the imagers 15a to 15d are stereo cameras, or a sonar or a laser (not illustrated) to detect objects around the vehicle 1, for example.

The determiner 402 determines whether to change the transmittance of the vehicle-shape data representing the vehicle 1 on the basis of information acquired by the acquirer 401.

For example, the determiner 402 determines whether to change the transmittance of the vehicle-shape data of the vehicle 1 on the basis of operation data acquired by the operation acquirer 412. When the driver performs rescaling operation, for example, the determiner 402 determines to change the transmittance to a value corresponding to the rescaling operation.

For example, the determiner 402 determines whether to change the transmittance of the vehicle-shape data representing the vehicle 1 on the basis of operation data acquired by the operation acquirer 412. When the driver performs enlarging or reducing operation, for example, the determiner 402 determines to change the transmittance to a value corresponding to the enlarging or reducing operation.

As another example, the determiner 402 determines whether to change the transmittance of the vehicle-shape data of the vehicle 1 on the basis of detection data acquired by the detection acquirer 413. More specifically, the determiner 402 determines whether the distance between an obstacle detected from the detection data acquired by the detection acquirer 413 and the vehicle 1 is equal to or below a certain value. On the basis of the result, the determiner 402 determines whether to change the transmittance of the vehicle-shape data representing the vehicle 1. When detecting an obstacle from the detection data within a certain distance from the vehicle in the traveling direction, for example, the determiner 402 may increase the transmittance of the vehicle-shape data to make the obstacle easily recognizable. The certain distance is set depending on an aspect of the embodiment.

The transmittance processor 403 performs transmittance changing processing to the vehicle-shape data stored in the vehicle-shape data storage 451, on the basis of a result of the determination of the determiner 402, for example. In this processing, the transmittance processor 403 may change the color of the vehicle-shape data. For example, the transmittance processor 403 may change the color of a region closest to an obstacle to allow the driver to recognize that the vehicle is approaching the obstacle.

In displaying the vehicle-shape data on the basis of the detection data, the display processor 406 of the present embodiment may display a region of the vehicle-shape data, corresponding to a portion of the vehicle 1 close to a detected object, at different transmittance from that of the other region. For example, if the determiner 402 determines that the distance between the obstacle and the vehicle 1 is a certain value or less, the transmittance processor 403 sets higher transmittance to a region of the vehicle-shape data, corresponding to a portion of the vehicle 1 close (adjacent) to the detected obstacle, than to the other region. This can facilitate the recognition of the obstacle. The present embodiment describes the example of heightening the transmittance of the certain region of the vehicle-shape data, corresponding to the portion of the vehicle 1 adjacent to a detected obstacle, than the transmittance of the other region. However, the transmittance of the certain region may be set lower than the transmittance of the other region.

As described above, the display processor 406 of the present embodiment can display a certain region of the vehicle-shape data at different transmittance from the other region. The certain region may be any region of the vehicle-shape data. For example, the certain region may be a region corresponding to a portion of the vehicle 1 close to a detected object or may be a region corresponding to a bumper or a wheel included in the vehicle-shape data. For another example, of the vehicle-shape data, a region representing a wheel may be set to the certain region and a region representing a roof may be set to another region, to display the two regions at different transmittances. Furthermore, according to the present embodiment, the transmittance may gradually change from the certain region toward another region. In the present embodiment, the certain region and another region may be a region corresponding to one component of the vehicle 1, a region across two or more components, or a region corresponding to a part of a component.

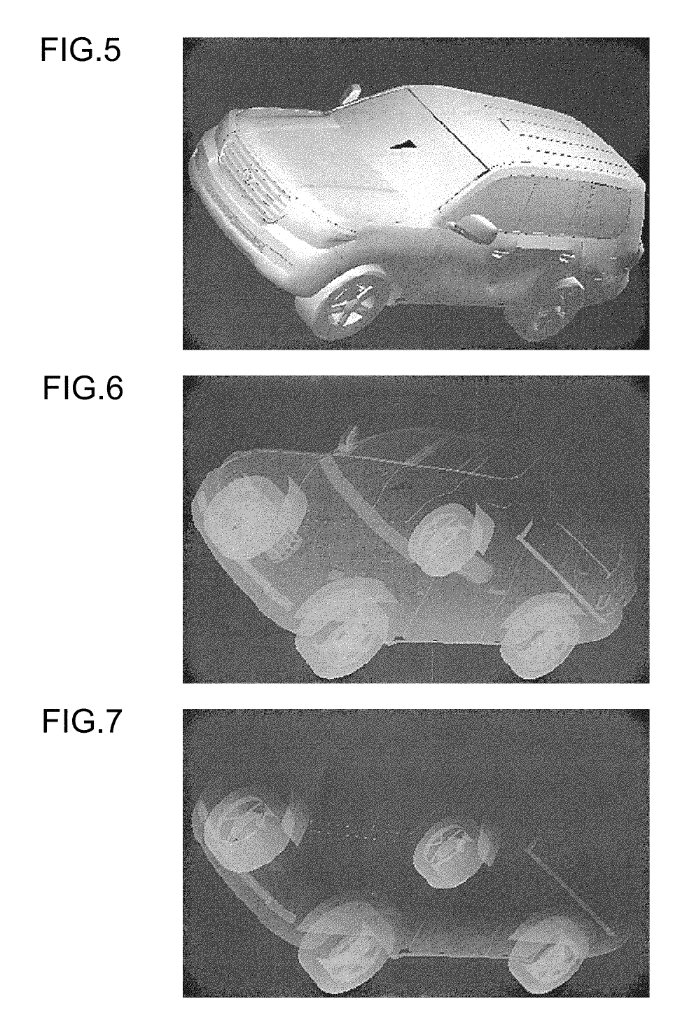

FIG. 5 is a diagram illustrating exemplary vehicle-shape data stored in the vehicle-shape data storage 451 in the present embodiment. In the vehicle-shape data illustrated in FIG. 5 the directions of the wheels are adjustable in accordance with the steering angle of the vehicle 1.

To change the transmittance in accordance with the result of determination of the determiner 402, the transmittance processor 403 performs transmission processing to the vehicle-shape data to set the vehicle-shape data at the changed transmittance. The transmittance may be set to any value from 0% to 100%.

For example, when changing the transmittance of the vehicle-shape data in accordance with the result of determination of the determiner 402, the transmittance processor 403 may change the transmittance depending on the distance between an obstacle detected from the detection data and the vehicle 1. Thereby, the display processor 406 can display the vehicle-shape data at the changed transmittance depending on the distance.

The determiner 402 may determine how to change the transmittance, on the basis of the operation data, for example. If the operation input 10 includes a touchscreen, the transmittance may be changed depending on the duration in which the vehicle-shape data is touched. If the determiner 402 determines the duration of touching to be long, for example, the transmittance processor 403 may perform transmission processing to increase the transmittance. The transmittance processor 403 may perform the transmission processing to increase the transmittance along with an increase in the number of touches detected by the determiner 402. As another example, the transmittance processor 403 may change the transmittance depending on the strength of touch detected by the determiner 402.

When the determiner 402 determines from the operation data that an arbitrary region of the vehicle-shape data is being touched, the transmittance processor 403 may set higher (or lower) transmittance to the arbitrary region than to the other region.

The transmittance processor 403 is not limited to performing transmission processing on the entire vehicle-shape data at the same transmittance. Each region of the vehicle-shape data may be set at different transmittance. For example, the transmittance processor 403 may set lower transmittance to a region, of the vehicle-shape data, including the wheels in the proximity of the ground, whereas it may set higher transmittance to a region as is further away from the ground.

FIG. 6 is a diagram of exemplary vehicle-shape data when a region corresponding to part of the vehicle 1 in height of two meters or above is completely transparent. As illustrated in FIG. 6, a region corresponding to part of the vehicle 1 in height of two meters or above is completely transparent, whereas a region corresponding to part of the vehicle 1 in height of below two meters is not completely transparent but gradually lowers in transmittance downward. Thus, making the region in height of two meters or above completely transparent can enlarge display area of the surroundings of the vehicle 1, while allowing the driver to recognize the situation of the wheels and the ground.

FIG. 7 is a diagram of exemplary vehicle-shape data when a region corresponding to part of the vehicle 1 in height of one meter or above is completely transparent. As illustrated in FIG. 7, vehicle-shape data of the vehicle 1 may be or may not be made completely transparent on the basis of the height of one meter or above. The reference of height for complete transparency, illustrated in FIG. 6 and FIG. 7, can be set as appropriate depending on the height of the vehicle 1 and the surrounding condition of the vehicle 1.

The transmittance processor 403 may perform transmission processing to the vehicle-shape data in a manner that gradually increases the transmittance from a region representing the wheels to a region representing the roof (ceiling). Thus, the display processor 406 displays the vehicle-shape data subjected to such transmission processing, thereby displaying the situation of the ground and the vehicle 1, with the area near the roof of the vehicle 1 completely transparent. This enables the driver to recognize the peripheral situation of the vehicle 1. The criterion for determining complete or non-complete transparency is not limited to the height of the vehicle 1.

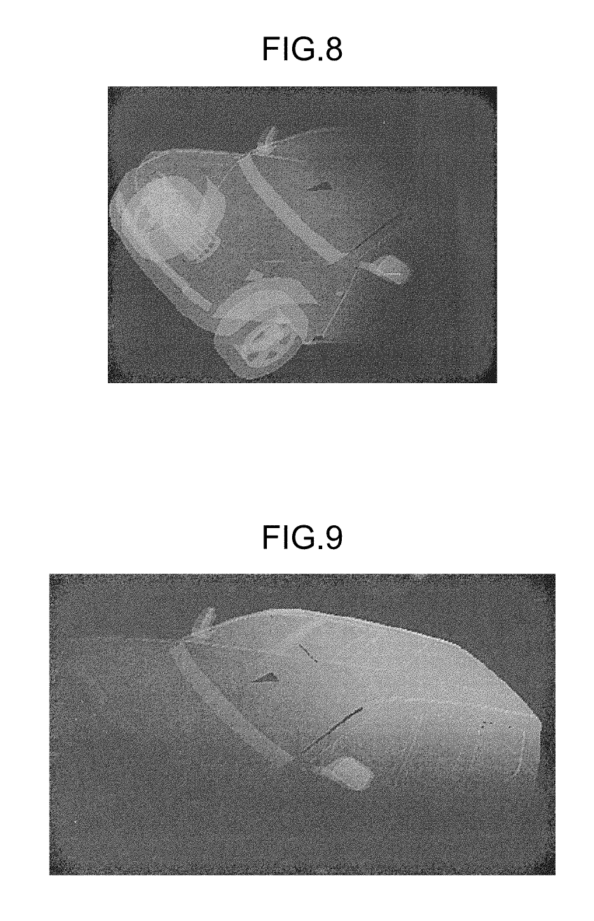

FIG. 8 is a diagram of exemplary vehicle-shape data when a region of the vehicle 1 behind a certain position is completely transparent. Displaying the region of the vehicle 1 ahead of the certain position makes it possible for the driver to recognize the condition of the contact areas of the wheels in addition to the positional relationship between the vehicle 1 and an obstacle located in the traveling direction. Display of the rear side of the vehicle 1 is unnecessary for checking the situation in the traveling direction. Making the rear side transparent enables the display of a wider area around the vehicle 1.

FIG. 8 illustrates an example that the vehicle 1 travels forward. When the determiner 402 determines occurrence of a gear shift from the operation data acquired by the operation acquirer 412, the transmittance processor 403 may change the region to be made transparent. When the determiner 402 determines that the traveling direction has changed from forward to backward, for example, the transmittance processor 403 changes the completely transparent region from the region behind the certain position of the vehicle 1 to the region ahead of the certain position of the vehicle 1. This can implement transmission processing in accordance with the traveling direction.

Referring to FIG. 6 and FIG. 7, the example of complete transparency of the region in a certain height T1 or above has been described. Alternatively, a region under the certain height T1 may be made completely transparent. FIG. 9 illustrates exemplary vehicle-shape data when the certain height T1 is set to one meter and a region corresponding to part of the vehicle 1 in height of one meter or below is made completely transparent. In the example of FIG. 9, the region of the vehicle 1 in height of one meter or more is not completely transparent but gradually decreases in transmittance upward.

Such vehicle-shape data is superimposed on image data showing the surroundings of the vehicle 1. Thereby, for example, the display processor 406 of the present embodiment can display the vehicle-shape data at such transmittance that gradually increases or decreases from a region (a certain region) representing a wheel to a region (another region) representing the roof.

Referring back to FIG. 4, the image combiner 404 combines data of multiple images acquired by the image acquirer 411, that is, multiple items of image data generated by the imagers 15 at their boundaries to generate one item of image data.

The image combiner 404 combines the items of image data so as to project the image data onto a virtual projection plane surrounding the vehicle 1.

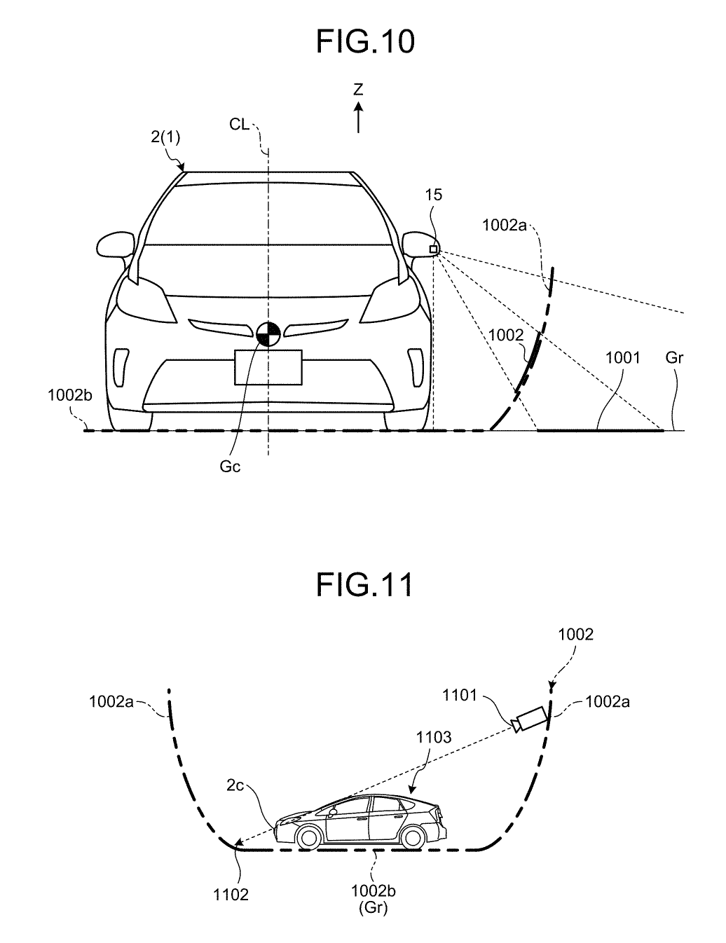

FIG. 10 is an exemplary schematic explanatory diagram depicting that the image combiner 404 projects image data 1001 onto a virtual projection plane 1002. In the example of FIG. 10, the virtual projection plane 1002 includes a bottom plane 1002b along a ground Gr, a side plane 1002a rising from the bottom plane 1002b, that is, from the ground Gr. The ground Gr is a horizontal surface perpendicular to a height direction Z of the vehicle 1 and is a surface which the tires contact. The bottom plane 1002b is a substantially circular flat surface, and is a horizontal plane with reference to the vehicle 1. The side plane 1002a is a curved surface in contact with the bottom plane 1002b.

As illustrated in FIG. 10, a virtual cross-section of the side plane 1002a passing a center Gc of the vehicle 1 and vertical to the vehicle 1 is elliptic or parabolic, for example. The side plane 1002a is, for example, a rotational surface around a center line CL passing the center Gc of the vehicle 1 along the height of the vehicle 1. The side plane 1002a surrounds the vehicle 1. The image combiner 404 generates composite image data to be projected onto the virtual projection plane 1002 from the image data 1001.

The viewpoint image generator 405 includes a superimposer 421 and a scaler 422, and generates viewpoint image data, as viewed from a given virtual viewpoint, from the composite image data projected on the virtual projection plane 1002. The present embodiment describes the example of generating a composite image and then generating viewpoint image data as viewed from a given viewpoint. Alternatively, only the viewpoint image data may be generated, using a lookup table for performing these operations at a time.

FIG. 11 is an exemplary schematic side view of vehicle-shape data 1103 and the virtual projection plane 1002. As illustrated in FIG. 11, the superimposer 421 superimposes, onto the virtual projection plane 1002, the vehicle-shape data 1103 subjected to transmission processing of the transmittance processor 403. The viewpoint image generator 405 converts the composite image data projected onto the virtual projection plane 1002 into viewpoint image data viewed from a viewpoint 1101 to a focus point 1102. The focus point 1102 is to become the center of the display area of the viewpoint image data.

The viewpoint 1101 is optionally settable by a user. The viewpoint is not limited to being outside the vehicle-shape data 1103 but may be set inside the vehicle-shape data 1103. In the present embodiment, the viewpoint image generator 405 generates viewpoint image data viewed from a viewpoint set in accordance with operation data acquired by the operation acquirer 412.

The scaler 422 scales up or down the vehicle-shape data 1103 displayed on the viewpoint image data generated by the viewpoint image generator 405, by moving the viewpoint 1101 closer to or away from the vehicle-shape data 1103 in accordance with the operation data.

The focus point 1102 is optionally settable by a user. For example, when enlarging the vehicle-shape data in accordance with the operation data acquired by the operation acquirer 412, the scaler 422 may move the focus point 1102 to be the central point of display to preset coordinates. Specifically, in response to a user's enlarging operation, the scaler 422 regards the operation as the user's intention to see the situation between the wheels and the ground Gr, and moves the focus point 1102 to a contact point between the wheels and the ground Gr. The present embodiment describes the example that the focus point 1102 is moved to the coordinates of the contact point between the wheels and the ground Gr. However, this is not intended to limit the position of the coordinates of a destination, and the coordinates are appropriately set in line with an aspect of the embodiment.

Thus, for enlarged display based on the operation data, the display processor 406 changes transmittance (for example, current transmittance) before the enlarging operation to higher transmittance, and displays viewpoint image data for moving the focus point to preset coordinates. Moving the focus point to the coordinates that the driver presumably intends to see makes it possible to display the vehicle-shape data and the surroundings of the vehicle in line with the driver's operation, which can improve usability of the device.

The display processor 406 performs display processing to the viewpoint image data generated by the viewpoint image generator 405. The present embodiment describes an example of displaying the viewpoint image data on the display 8, but is not intended to limit the display to displaying the viewpoint image data on the display 8. For example, the viewpoint image data may be displayed on a head-up display (HUD).

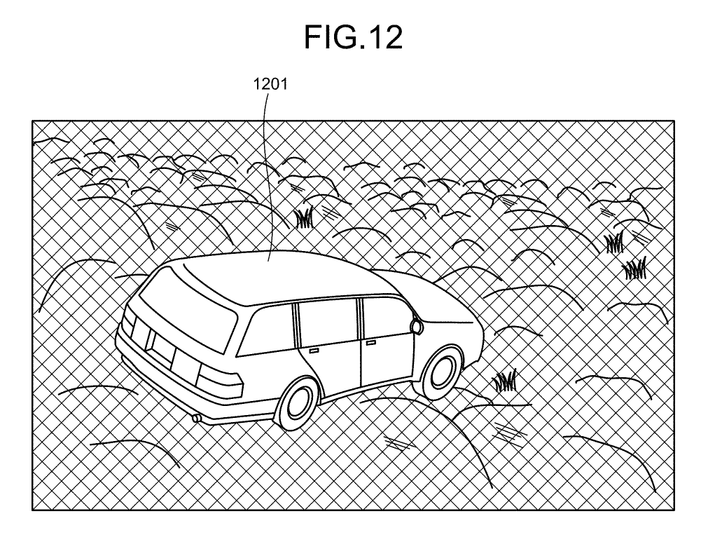

FIG. 12 is a diagram illustrating exemplary viewpoint image data displayed by the display processor 406. In the example of FIG. 12, vehicle-shape data 1201, subjected to transmission processing of the transmittance processor 403 at transmittance 0%, is superimposed. In the example of FIG. 12, the vehicle-shape data 1201 cannot be made transparent to check the situation on the opposite side of the vehicle.

Meanwhile, the display processor 406 of the present embodiment displays a certain region of the vehicle-shape data and the other region at different transmittances, when displaying the viewpoint image data which is composite image data, generated on the basis of image data and representing the surroundings of the vehicle, on which the vehicle-shape data is superimposed in accordance with the current site of the vehicle 1. The following describes an example of displaying the viewpoint image data including vehicle-shape data of which a certain region and the other region have different transmittances. The present embodiment describes superimposition of the vehicle-shape data in line with the current position of the vehicle 1. However, the vehicle-shape data may be superimposed on another position. For example, the vehicle-shape data may be superimposed on a position on an estimated course of the vehicle 1 or on a previous position of the vehicle 1.

The following describes viewpoint image data to be displayed by the display processor 406 when the determiner 402 determines to make a region of the vehicle 1 in the certain height T1 or above transparent.

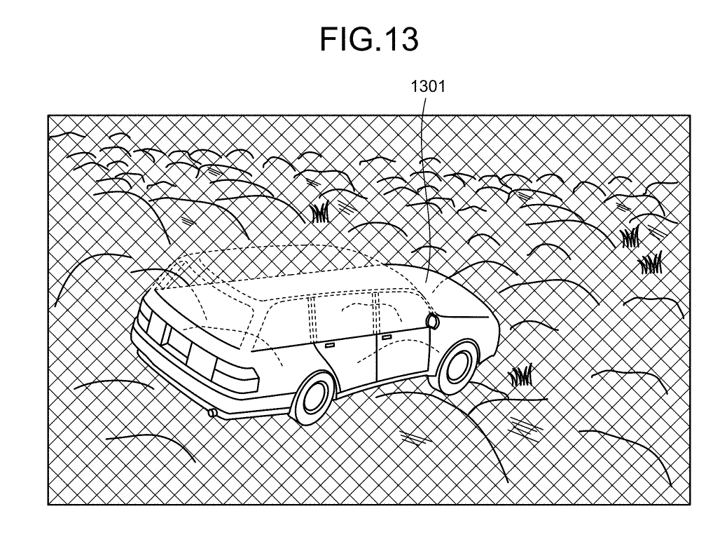

FIG. 13 is a diagram illustrating exemplary viewpoint image data displayed by the display processor 406. In the example of FIG. 13, vehicle-shape data 1301, of which a region in the certain height T1 or above is set at transmittance K1 and a region below the certain height T1 is set at transmittance K2 (where K1>K2>0%) by the transmittance processor 403, is superimposed. Thus, due to the lower transmittance of the vehicle-shape data below the certain height, the positional relationship between the vehicle 1 and the ground is recognizable. Also, due to the region at the transmittance K2, the situation of the opposite side of the vehicle 1 is recognizable to some extent. Meanwhile, due to the higher transmittance of the vehicle-shape data in the certain height T1 or above, the situation of the opposite side of the vehicle 1 can be checked in more detail. Thereby, the driver can recognize the situation of a wider area.

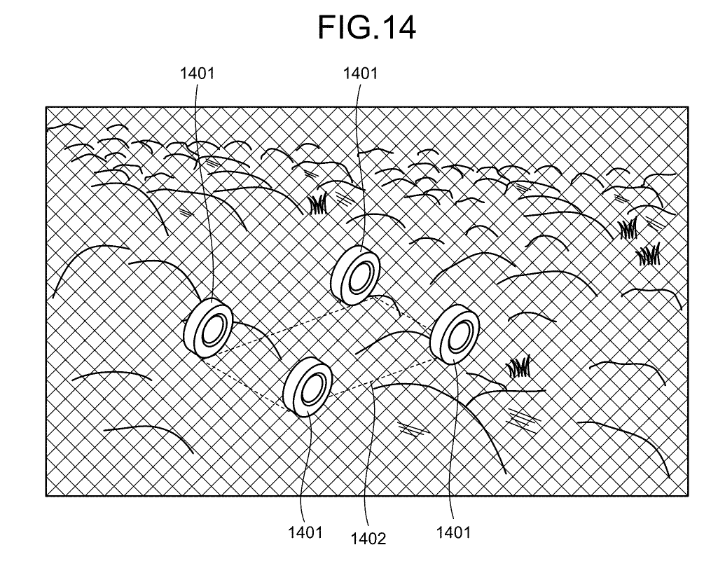

As another way of differentiating the transmittance, the elements of the vehicle 1 may be individually set to different transmittances. FIG. 14 is a diagram illustrating exemplary viewpoint image data displayed by the display processor 406. In the example of FIG. 14, vehicle-shape data, of which regions 1401 corresponding to the wheels are set at transmittance 0% and the region other than the wheels is set at transmittance 100% by the transmittance processor 403, is superimposed.

Such a display may be a result of the driver's operation to display only the wheels. The determiner 402 determines on the basis of the operation data indicating display of the wheels that the region other than the wheels is made transparent at 100%. The transmittance processor 403 performs the transmission processing in accordance with a result of the determination. The present embodiment describes the example of displaying only the wheels. However, the elements of the vehicle 1 to display are not limited to the wheels. Other elements such as bumpers may be displayed together with the wheels. The present embodiment describes the example of setting the region corresponding to the wheels at transmittance 0% while setting the other region at transmittance 100%. Without being limited thereto, the region corresponding to the wheels needs to be set at lower transmittance than the other region.

Thus, the display processor 406 of the present embodiment can display vehicle-shape data subjected to such transmission processing that the regions (certain region) corresponding to at least one or more of the bumpers or wheels are set at lower transmittance than the other region of the vehicle 1. The present embodiment describes transmission processing for setting regions (certain region) corresponding to at least one or more of the bumpers or wheels at lower transmittance than the other region. Alternatively, the regions may be set at higher transmittance than the other region through transmission processing.

The present embodiment is not intended to limit the transmission processing to the one based on the operation data. For example, when the determiner 402 determines that the vehicle is traveling off-road, from detection data acquired by the detection acquirer 413, the transmittance processor 403 may perform transmission processing for setting the regions of at least one or more of the wheels or the bumpers at lower transmittance than the other region, as illustrated in FIG. 14.

The present embodiment describes the example of changing the transmittance according to the operation data or the detection data, when superimposing, for display, the vehicle-shape data on the display data based on image data and representing the surroundings of the vehicle, in accordance with the current position of the vehicle. The data used in changing the transmittance is, however, not limited to such operation data and detection data, and may be any given data acquired from outside.

The imagers 15 of the current vehicle 1 cannot image a region 1402. In the present embodiment, the image combiner 404 thus combines image data previously generated by the imagers 15 to generate composite image data. The previous image data generated by the imagers 15 may be image data of the vehicle 1 generated two meters before the current position. Such image data may be used as image data representing the condition of the underfloor area of the vehicle 1. The region 1402 is not limited to displaying previous image data. The region may be merely painted in a certain color.

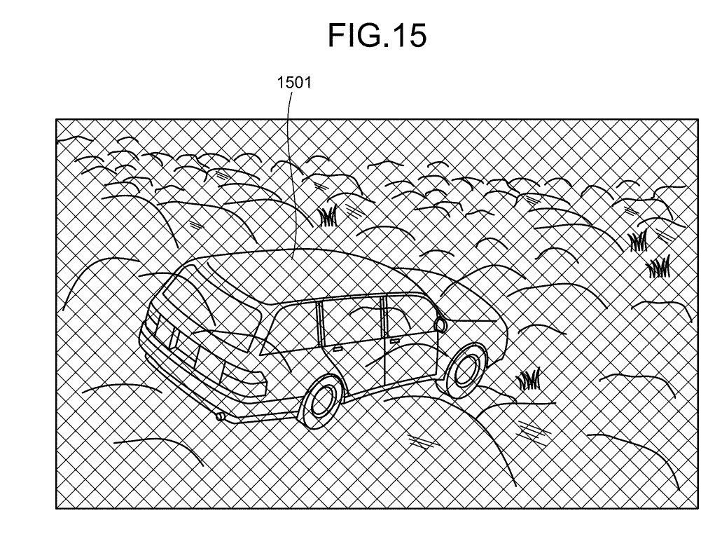

FIG. 15 is a diagram illustrating exemplary viewpoint image data displayed by the display processor 406. In the example of FIG. 15, vehicle-shape data 1501, processed by the transmittance processor 403 at transmittance 100% except for the lines of vehicle-shape data, is superimposed. Thus, owing to the transparent vehicle-shape data, the user can check the surrounding situation of the vehicle 1. The display of FIG. 15 may be, for example, a result of a user's selection of “display the lines of the vehicle alone”.

In the examples of FIG. 13 to FIG. 15, the viewpoints are set outside the vehicle (vehicle-shape data). The present embodiment is, however, not intended to limit the location of the viewpoints to outside the vehicle (vehicle-shape data).

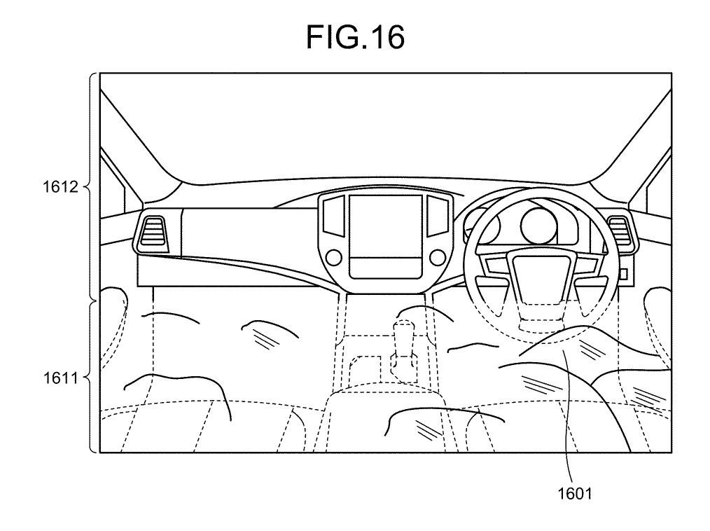

FIG. 16 is a diagram illustrating exemplary viewpoint image data displayed by the display processor 406. In the example of FIG. 16, a viewpoint is situated inside the vehicle-shape data. That is, the surroundings of the vehicle 1 are displayed through the vehicle interior included in the vehicle-shape data. The display illustrated in FIG. 16 may be a result of, for example, a user's viewpoint operation.

In the example of FIG. 16, in an interior display of the vehicle 1 based on the vehicle-shape data, a region in height below a certain height T2 is displayed at higher transmittance than a region in height above the certain height T2. That is, to display the inside of the vehicle 1, a region 1611 below the certain height T2 is set at higher transmittance K3 for the purpose of allowing the condition of objects on the ground to be recognizable. A region 1612 above the certain height T2 is set to lower transmittance K4, which allows the user to know that the inside of the vehicle is being displayed (transmittance K3>transmittance K4).

That is, in response to an operation to move the viewpoint to the inside of the vehicle-shape data, the display processor 406 displays viewpoint image data showing the surroundings of the vehicle from the viewpoint through the interior of the vehicle. In this case, the transmittance processor 403 subjects vehicle-shape data to such transmission processing that the transmittance gradually decreases from the underfloor to the ceiling in the interior, and the display processor 406 displays the viewpoint image data representing the surroundings of the vehicle 1 through the processed vehicle-shape data. The present embodiment describes the example that the transmittance processor 403 performs transmission processing such that transmittance gradually decreases from the underfloor to the ceiling in the interior. Alternatively, the transmittance processor 403 may perform transmission processing to gradually increase the transmittance from the underfloor to the ceiling.

As described above, the display processor 406 of the present embodiment changes modes of transparency of the vehicle-shape data when the viewpoint is situated inside the vehicle-shape data and when the viewpoint is situated outside the vehicle-shape data.

The determiner 402 determines according to the operation data acquired by the operation acquirer 412 whether or not the viewpoint is situated inside the vehicle-shape data (vehicle 1) by a user operation. When the determiner 402 determines that the viewpoint is situated inside the vehicle-shape data (vehicle 1), the transmittance processor 403 sets higher transmittance K3 for the region below the certain height T2 and lower transmittance K4 for the region above the certain height T2 for transmission processing. When the determiner 402 determines that the viewpoint is situated outside the vehicle-shape data (vehicle 1), the transmittance processor 403 sets lower transmittance K2 for the region below the certain height T1 and higher transmittance K1 for the region above the certain height T1 for transmission processing. In the present embodiment, the transmission processing is changed depending on whether or not the viewpoint is situated inside the vehicle-shape data (vehicle 1).

With the viewpoint set inside the vehicle-shape data (vehicle 1), the transmittance processor 403 may change the region to be transparent on the basis of vehicle velocity information, gear-shift data, or blinker information acquired by the acquirer 401. For example, when the determiner 402 determines that the traveling direction has been switched by a gear shift, the transmittance processor 403 may make a region in the traveling direction transparent.

As another example, if the determiner 402 determines that the driver has steered right or left on the basis of steering-angle data or operation data representing turning-on of the blinker, the transmittance processor 403 performs transmission processing to set a higher transmittance for a certain region, of the vehicle-shape data, in the turning direction of the vehicle 1 than the other region in a direction opposite to the turning direction of the vehicle. The display processor 406 displays the vehicle-shape data showing the region in the turning direction of the vehicle 1 at higher transmittance, which can facilitate surrounding check in the turning direction through the vehicle-shape data.

The present embodiment describes the example of transmission processing by which the certain region in the turning direction of the vehicle 1 is set at higher transmittance than the other region in the opposite direction. It is necessary to differentiate transmittances between the certain region in the turning direction and the other region in the opposite direction. For example, the certain region in the turning direction may be set at lower transmittance than the other region in the opposite direction through transmission processing.

Further, the determiner 402 may switch the screen to display, in response to a detected touch on a certain region from the operation data. For example, when the determiner 402 determines that a dead zone of the vehicle-shape data displayed on the display 8 has been touched, the display processor 406 may control the display 8 to display, as an underfloor image of the vehicle 1, image data generated when the vehicle 1 is located two meters behind (in the past).

Furthermore, when the determiner 402 determines from the operation data that any region of the vehicle-shape data is touched, the display processor 406 may raise the brightness around the region to look brighter, as if illuminated with virtual light through display processing.

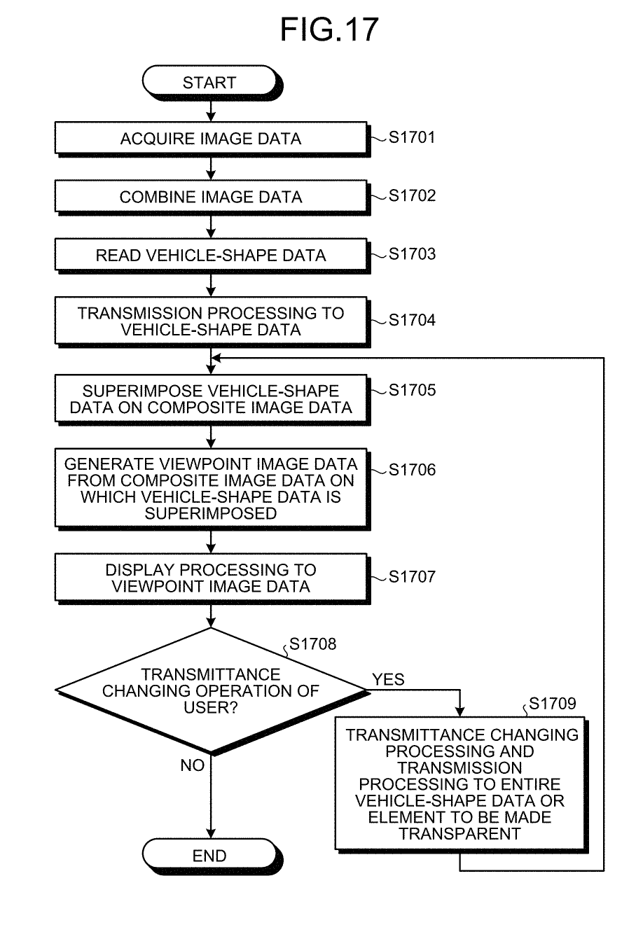

Next, first display processing of the ECU 14 of the present embodiment will be described. FIG. 17 is a flowchart illustrating the above processing of the ECU 14 of the present embodiment.

The image acquirer 411 acquires image data from the imagers 15a to 15d that image the surroundings of the vehicle 1 (S1701).

The image combiner 404 combines multiple items of image data acquired by the image acquirer 411 to generate composite image data (S1702).

The transmittance processor 403 reads the stored vehicle-shape data from the vehicle-shape data storage 451 of the SSD 14f (S1703).

The transmittance processor 403 performs transmission processing on the vehicle-shape data at certain transmittance (S1704). The certain transmittance is a preset value in accordance with initial values of a viewpoint and a focus point.

Then, the superimposer 421 superimposes the vehicle-shape data subjected to the transmission processing on the composite image data (S1705).

The viewpoint image generator 405 generates viewpoint image data from the composite image data including the superimposed vehicle-shape data on the basis of the initial values of the viewpoint and the focus point (S1706).

The display processor 406 displays the viewpoint image data on the display 8 (S1707).

After the display of the viewpoint image data, the determiner 402 determines whether or not the user has changed the transmittance or the element to be made transparent, on the basis of the operation data acquired by the operation acquirer 412 (S1708).

When the determiner 402 determines that the transmittance has changed or the element to be made transparent has been switched (Yes at S1708), the transmittance processor 403 subjects the entire vehicle-shape data or the element to be made transparent (for example, element except for the wheels and the bumpers) to transmission processing in accordance with the transmittance changing processing or changing operation (S1709). The processing returns to Step S1705.

If the determiner 402 determines that there has been no transmittance changing operation or no element switching operation (No at S1708), the processing ends.

The procedure of FIG. 17 illustrates the example of changing the element to be made transparent or the transmittance in accordance with a user operation. However, such transmittance changing is not limited to the one in response to a user operation. The following describes an example of changing the transmittance according to the distance between the vehicle 1 and an obstacle.

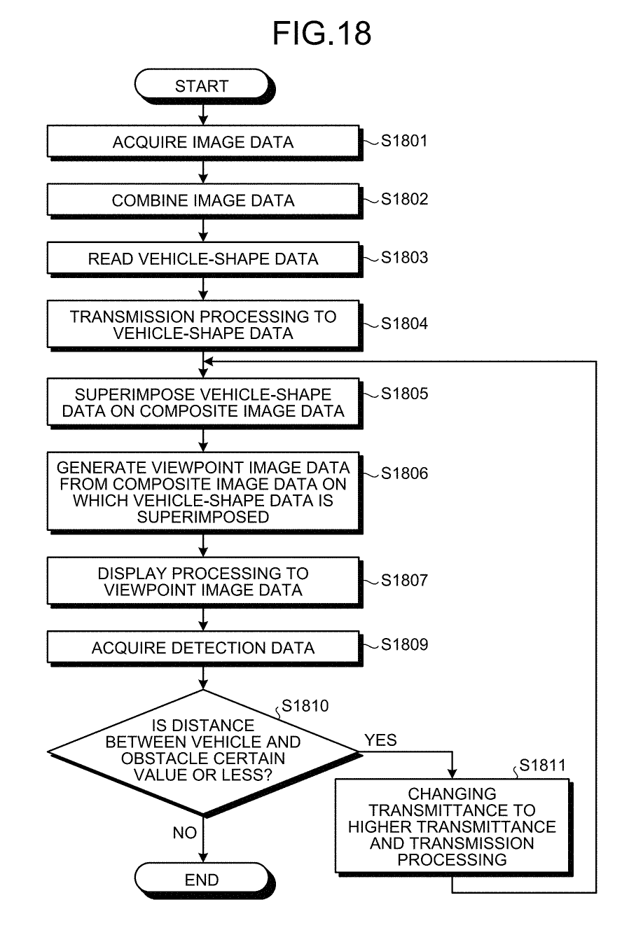

Second display processing of the ECU 14 of the present embodiment will now be described. FIG. 18 is a flowchart illustrating the above processing of the ECU 14 of the present embodiment.

S1801 through S1807 of the flowchart illustrated in FIG. 18 are identical to S1701 through S1707 illustrated in FIG. 17, therefore, a description thereof will be omitted.

The detection acquirer 413 acquires detection data from the sonar or the laser, for example (S1809).

The determiner 402 determines on the basis of the detection data whether the distance between the vehicle 1 and an obstacle located in the traveling direction of the vehicle 1 is a certain value or less (S1810).

If the determiner 402 determines that the distance between the vehicle 1 and the obstacle located in the traveling direction of the vehicle 1 is the certain value or less (Yes at S1810), the transmittance processor 403 changes the transmittance, set before the detection, of the entire vehicle-shape data or of a region adjacent to the obstacle to higher transmittance, and performs transmission processing on the entire vehicle-shape data or the region adjacent to the obstacle (S1811). Then, the processing returns to Step S1805. The certain value may be, for example, set to a distance in which the obstacle enters a dead zone hidden by the vehicle body and disappears from the sight of the driver inside the vehicle 1. The certain value may be set to an appropriate value in accordance with an aspect of the embodiment.

If the determiner 402 determines that the distance between the vehicle 1 and the obstacle located in the traveling direction of the vehicle 1 is not the certain value or less (No at S1810), the processing ends.

The present embodiment is not limited to changing the transmittance in response to a user's direct operation to the transmittance. The transmittance may be changed in response to another operation. In view of this, the following describes an example of changing the transmittance in accordance with a scale factor. That is, when the user intends to display an enlarged image of the vehicle to see the relationship between the vehicle 1 and the ground, the transmittance may be lowered. When the user intends to display a reduced image of the vehicle to check the surroundings of the vehicle 1, the transmittance may be increased.

Through the above processing, the present embodiment can display the vehicle-shape data and the surroundings of the vehicle 1 in line with a current situation by changing the transmittance of the vehicle-shape data depending on the positional relationship between the vehicle 1 and an object around the vehicle 1. This can improve the usability of the device.

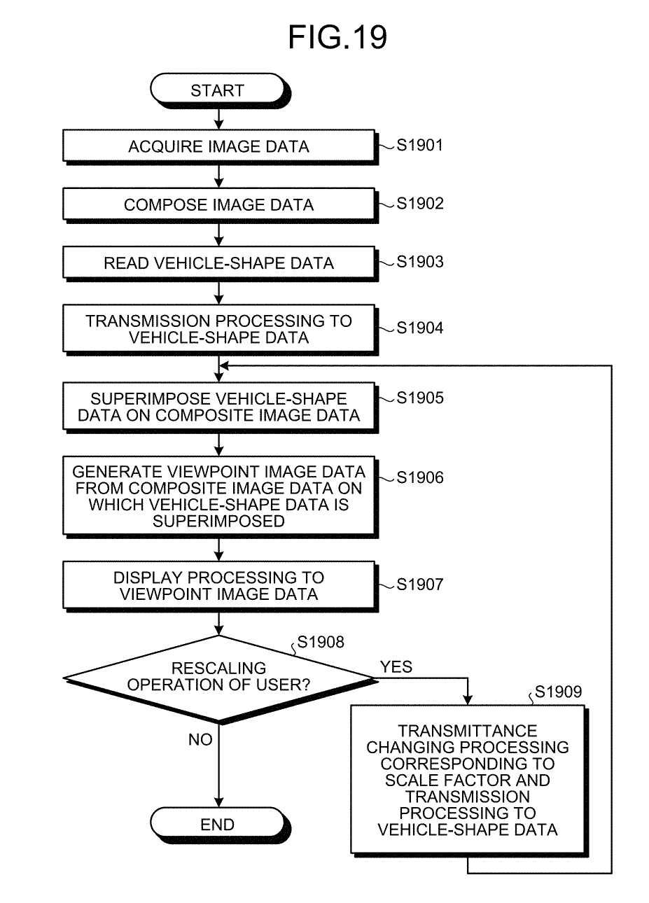

Third display processing of the ECU 14 of the present embodiment will now be described. FIG. 19 is a flowchart illustrating the above processing of the ECU 14 of the present embodiment.

S1901 through S1907 of the flowchart illustrated in FIG. 19 are identical to S1701 through S1707 illustrated in FIG. 17, therefore, a description thereof will be omitted.

After display of the viewpoint image data, the determiner 402 determines whether the user has performed rescaling operation (that is, moving the viewpoint closer to or away from the vehicle-shape data), on the basis of the operation data acquired by the operation acquirer 412 (S1908).

When the determiner 402 determines that the user has performed the rescaling operation (Yes at S1908), the transmittance processor 403 changes the transmittance of the vehicle-shape data to transmittance corresponding to a scale factor and performs transmission processing to the vehicle-shape data (S1909). The correspondence between the scale factor and the transmittance is pre-defined. The processing then returns to Step S1905.

At Step S1906, in generating the viewpoint image data, the scaler 422 sets the focus point and the viewpoint in accordance with the scale factor. The viewpoint image generator 405 generates viewpoint image data on the basis of the set focus point and viewpoint.

For enlarging processing, the viewpoint image generator 405 may move the focus point to a preset position according to an enlargement ratio. That is, it may be difficult for the user to set the focus point in the enlarging operation. In addition, in the enlarging operation, many users request to see the situation of the vehicle and the ground. According to the present embodiment, in the enlarging operation, the focus point is controlled to move to the contact point between the wheels and the ground along with the enlargement. This can facilitate the operation of the user to display his or her intended checking location.

When the determiner 402 determines that the user has not performed recalling operation at S1908 (No at S1908), the processing ends.

Thus, to display an enlarged image on the basis of the operation data, the display processor 406 of the present embodiment displays viewpoint image data on which vehicle-shape data at changed transmittance higher than that before the enlarging operation is superimposed. To display a reduced image on the basis of the operation data, the display processor 406 of the present embodiment displays viewpoint image data on which vehicle-shape data at changed transmittance lower than that before the reducing operation is superimposed.

Through the above processing, the present embodiment enables the display of the vehicle-shape data and the surroundings of the vehicle 1 in response to the driver's operation by changing the transmittance in accordance with the driver's enlarging operation or reducing operation. This can improve usability of the device.

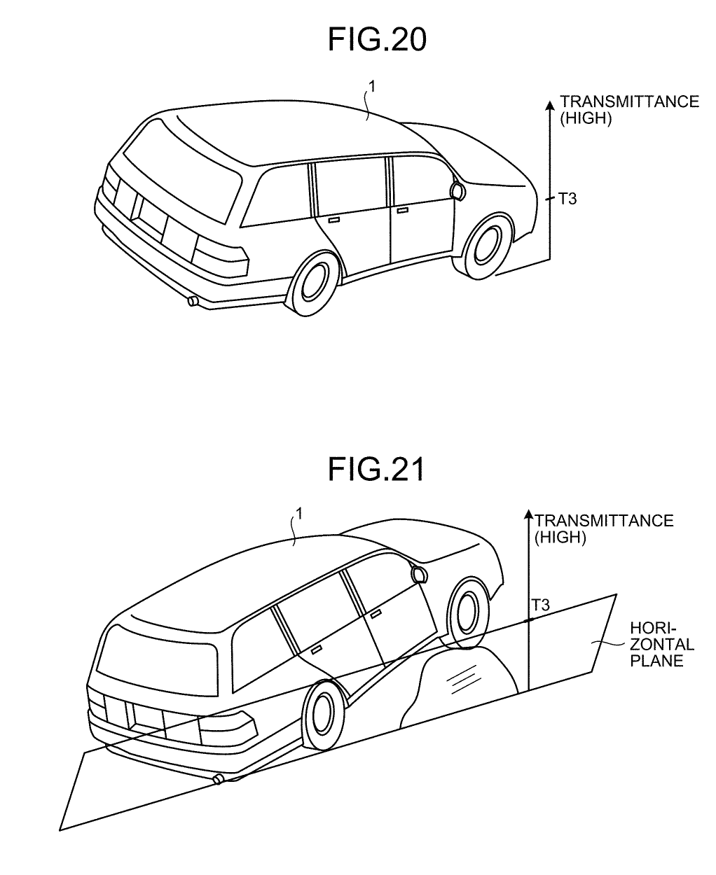

The above embodiment describes an example of setting the contact point between the wheels and the ground as a reference point and defining the vertical distance from the reference point to be the height of the vehicle, as illustrated in FIG. 20. For example, the region above the height T3 or more (above the wheels and the bumpers) from the reference point is set at transmittance 80%, and the region below the height T3 is set at transmittance 0%. In this case, the vehicle-shape data is displayed such that the upper region in the height T3 or more is set at transmittance 80% while the wheels and the bumpers are recognizable.

Further, in the present embodiment, for example, upon determining that there is anomaly in the image data generated by the imagers 15, the determiner 402 may instruct the transmittance processor 403 not to perform transmission processing.

First Modification FIG. 21 illustrates an example of setting, as the height of the vehicle, a vertical distance from a horizontal plane, defined as a reference plane, on which the vehicle 1 is located. In the example of FIG. 21, the detection acquirer 413 detects inclination of the vehicle 1 on the basis of acceleration information acquired from the accelerometer 26. The transmittance processor 403 estimates the position of the horizontal plane on which the vehicle 1 is grounded, from the inclination of the vehicle 1. The transmittance processor 403 performs transmission processing to the vehicle-shape data on the basis of the height from the horizontal plane. With the region in the height T3 or more from the horizontal plane set at transmittance 80%, in the example of FIG. 21 in which the vehicle 1 hits a rock, the front region of the vehicle-shape data including the wheels and the bumper becomes transparent at transmittance 80%.

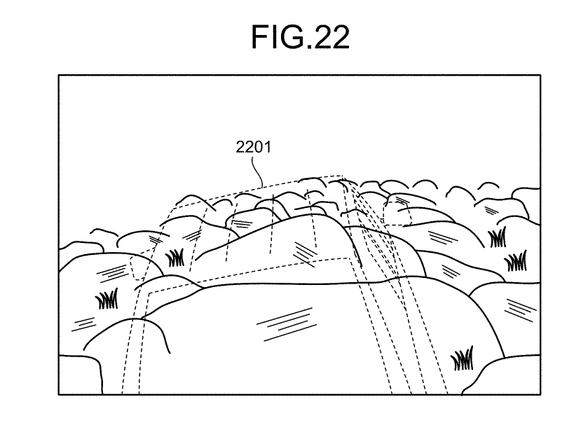

FIG. 22 is a diagram illustrating an exemplary screen display displayed by the display processor 406 of the modification. FIG. 22 illustrates an example that, with the region in the height T3 or more from the horizontal plane set at transmittance 80%, the front region of vehicle-shape data including the wheels and the bumper becomes substantially transparent when the vehicle 1 runs on rocks.

As illustrated in FIG. 22 in which the vehicle 1 runs upon rocks, the front region of vehicle-shape data including the wheels and the bumper is substantially transparent, which allows the user to easily understand the condition of the ground.

Second Modification

The above embodiment and modification has described the processing for displaying the current situation. The embodiment and modification are not limited to such an example of displaying the current situation. For example, in response to a user operation, the display processor 406 may display a screen that shows a previous situation of the vehicle 1. In this case, the image combiner 404 uses previous composite image data, and the transmittance processor 403 changes the color of vehicle-shape data to subjects the data to transmission processing. The transmission processing is the same as that in the above embodiment. The color of the vehicle-shape data may be, for example, gray and sepia representing the past. Thereby, the user can understand that a previous situation is being displayed.

Third Modification A third modification illustrates an example of transmission processing (to heighten the transmittance) during enlargement, reduction, or rotation. According to the third modification, when the operation acquirer 412 acquires operation data representing enlargement, reduction, or rotation, the transmittance processor 403 performs transmission processing at higher transmittance (for example, complete transparency) than the one before the enlarging, reducing, or rotating operation of the driver, while the determiner 402 determines that the driver is performing the enlarging, reducing, or rotating operation.

In other words, in this modification, while the driver is performing enlarging, reducing, or rotating operation (i.e., while the driver is moving the vehicle-shape data), the display processor 406 displays the viewpoint image data on which the vehicle-shape data set at higher transmittance than the one before the enlarging, reducing, or rotation operation, is superimposed. In this process, as with the above embodiment, the focus point may be moved to a preset position along with the enlargement.

This enables the user to intuitively understand that the operation is ongoing, and provides the user with the operability for suitable display upon checking the surroundings of the vehicle 1.

As described above, for moving the vehicle-shape data (through enlarging, reducing, or rotating operation, for example) on display in accordance with the operation data, the display processor 406 of the third modification displays the viewpoint image data on which the vehicle-shape data set at higher transmittance than current transmittance is superimposed.

Fourth Modification

The above embodiment and modifications have described the example of displaying the viewpoint image data on the display 8. The embodiment and modifications are however not limited to displaying the data on the display 8. In a fourth modification, the data is displayable on a head-up display (HUD) by way of example. According to the fourth modification, transmittance is changed depending on a location of display of the viewpoint image data.

For example, the operation acquirer 412 acquires operation data indicating a change of the display location, the determiner 402 determines whether the display location has been changed. The transmittance processor 403 performs transmission processing on the basis of a result of the determination. That is, the display 8 and the HUD differ in contrast, so that the transmittance processor 403 performs the transmission processing at transmittance which is easily viewable by the user, depending on the display location. The transmittance is appropriately set for each of the display 8 and the HUD depending on their display performance.

As described above, the display processor 406 of the fourth modification displays the viewpoint image data on which vehicle-shape data, set at the transmittance depending on the location of display, is superimposed. Changing the transmittance depending on the location of display makes it possible to provide better viewability to the user.

According to the above embodiment and modifications, a certain region of the vehicle-shape data is displayed at different transmittance from the other region. This enables the driver to check the situation of the certain region or the other region and recognize the surroundings of the vehicle 1 at the same time. The driver can thus easily check the situation of the vehicle 1 and the surroundings of the vehicle 1.

According to the above embodiment and modifications, the transmittance of the vehicle-shape data is changed according to acquired data. This makes it possible to display the vehicle-shape data and the surroundings of the vehicle in line with the current situation, thereby improving the usability of the device.

Certain embodiments of the present invention have been described as above, however, these embodiments are merely exemplary and not intended to limit the scope of the present invention. These new embodiments can be implemented in other various aspects, and omission, replacement, and change can be made as appropriate without departing from the spirit of the invention. These embodiments and modifications are included in the scope and the spirit of the invention and included in an invention of appended claims and the equivalent thereof.

1. A display control device, comprising:
an acquirer configured to acquire image data from an imager that images surroundings of a vehicle;
storage that stores therein vehicle-shape data representing a three-dimensional shape of the vehicle; and
a display processor configured to display a certain region of the vehicle-shape data at transmittance different from transmittance of another region different from the certain region, when superimposing, for display, the vehicle-shape data on display data, the display data being based on the image data and represents the surroundings of the vehicle.

2. The display control device according to claim 1, wherein
the display processor displays the certain region of the vehicle-shape data at different transmittance from transmittance of the another region, the certain region being a region representing at least one or more of bumpers or wheels.

3. The display control device according to claim 1, wherein
the display processor displays the vehicle-shape data at such transmittance that heightens or lowers from the certain region being a region representing a wheel to the another region being a region representing a roof.

4. The display control device according to claim 1, wherein
the storage stores therein a shape of an interior of the vehicle as the vehicle-shape data, and
in superimposing the vehicle-shape data on the display data for display with a viewpoint situated inside the vehicle-shape data, the display processor displays the interior and the surroundings of the vehicle while changing the transmittance from a floor to a ceiling in the interior.

5. The display control device according to claim 4, wherein
the display processor changes modes of transparency of the vehicle-shape data when the viewpoint is situated inside the vehicle-shape data and when the viewpoint is situated outside the vehicle-shape data.

6. The display control device according to claim 1, wherein
the acquirer further acquires steering-angle data representing steering by a driver of the vehicle, and
for display of the display data on which the vehicle-shape data is superimposed, when determining on the basis of the steering-angle data that the driver has steered right or left, the display processor displays the certain region and the another region at different transmittances, the certain region being a region in a turning direction of the vehicle, the another region being a region in a direction opposite to the turning direction of the vehicle.

7. The display control device according to claim 1, wherein
the acquirer further acquires detection data from a detector that detects an object around the vehicle, and
the display processor further displays the certain region and the another region at different transmittances on the basis of the detection data, the certain region being a region corresponding to part of the vehicle closer to the object.
